(19) United States
(12) Patent Application Publication
(10) Pub. No.: US 2002/0060802 A1
(43) Pub. Date: May 23, 2002

(54) Image forming apparatus and image forming method for processing data described with structured description language

(76) Inventor: Yasuhiro Hino, Kanagawa (JP)

Correspondence Address: FITZPATRICK CELLA HARPER & SCINTO, 30 ROCKEFELLER PLAZA, NEW YORK, NY, 10112, US

(21) Appl. No.: 09/987,529

(22) Filed: Nov. 15, 2001

(30) Foreign Application Priority Data
Nov. 17, 2000 (JP) 352000/2000
Nov. 1, 2001 (JP) 336435/2001

(51) Int. Cl. G06F 15/00; B41B 1/00; G06K 1/00

(52) U.S. Cl. 358/1.13; 358/1.18

(57) ABSTRACT

The invention provides a high-quality efficient print system of load diffusion type, capable of printing document data described with a structured description language based on page concept.

A printing apparatus transmits, to a server, information for identifying the document data and physical layout information required for determining the layout of the document data, and the server converts the document data into document data described with the structured description language capable of page layout based on the received information.

### BACKGROUND OF THE INVENTION

1. Field of the Invention

The present invention relates to an image forming apparatus and an image forming method, and more particularly to an image forming apparatus and an image forming method for output with page layout of document data described with a structured description language.

2. Related Background Art

The use of electronic documents is accelerated in every field by the rapid popularization of the use of the personal computers and the internet. However, since the data format of the electronic document (hereinafter called document data) depends on the application used for editing the document, it is necessary to prepare an application supporting the data format of the document data in order to view such electronic document.

In order to dispense with such application, there are becoming popular document data described in a structured description language, not dependent on a particular application, such as HTML (hyper text markup language), SGML (standard generalized markup language) or XML (extensible markup language).

The structured description language is generally a language principally designed for display on a display image with a software for viewing a document, namely a browser, so that it does not include the concept of page. In case of displaying a document on the display with such browser, the concept of page is not required since the displayed image can be arbitrarily changed in width or in height or can be scrolled.

However, in case of utilizing such structured description language as a page description language for printer control, namely in case of printing the document data described in such structured description language, there is required a process of assigning the document to pages. For this reason, there is being recently developed a structured description language capable of page layout. By employing for example a page-making rule for printing, the document data described with a structured description language lacking the concept of page can be converted into document data described with the structured description language capable of page layout.

Such process of converting the document (or document data) described with the structured description language lacking the concept of page into the document (or document data) described with the structured description language is called “formatting”.

FIG. 16 shows an example of the document described with the structured description language lacking the concept of page. A general browser can change the size of the displayed image or vertically and horizontally scroll the image by means of a scroll bar.

On the other hand, FIG. 17 shows an example of the document described with the structured description language after formatting. The document after formatting can be displayed or printed in the unit of a page.

On the other hand, the document described with the structured description language, not requiring a particular application as explained in the foregoing, can be printed in a terminal not containing the application if the printing apparatus can interpret the structured description language. As the printing apparatus can acquire the document data and execute printing thereof, by instructing the storage location of the document data even from an external device such as a portable information terminal or a mobile telephone, whereby the printing of the document on the web server is rendered possible. In the following description, such print instruction will be called “reference print instruction”.

### SUMMARY OF THE INVENTION

In the aforementioned formatting process, since the structured description language is a device-independent language, the document data are generally laid out on a logic page. Therefore, in order to print the document data described with the structured description language, it is necessary in the formatting process to execute layout of the document data into a physical page, and, for this purpose, it is necessary to determine the output sheet size and the layout direction such as portrait/landscape.

However, in case of executing the aforementioned reference print instruction in a print system in which the formatting process is executed in a web server (also including other servers), the server cannot know the size of the physical page or the layout direction thereof at the formatting operation. For this reason there results a drawback that the server can only execute layout on the logic page but cannot achieve layout of satisfactory looking, matching the actual output sheet size.

In consideration of the foregoing, the object of the present invention is to provide an image forming apparatus and an image forming method adapted for use in a high-quality and efficient print system of load dispersion type, in which a printing apparatus informs a server, executing the formatting process, of the sheet size and the layout direction and the server converts the document data described with the structured description language into document data assigned to physical pages.

### BRIEF DESCRIPTION OF THE DRAWINGS

FIG. 1 is a lateral cross-sectional view showing the configuration of a laser beam printer embodying the present invention;

FIG. 2 is a block diagram showing the configuration of a print system embodying the present invention;

FIG. 3 is a functional block diagram showing the basic configuration of a printing apparatus embodying the present invention;

FIG. 4 is a view showing an example of reference print instruction;

FIG. 5 is a block diagram showing the configuration of a web server embodying the present invention;

FIG. 6 is a view showing an example of the document data described with XML;

FIG. 7 is a view showing an example of a style sheet;

FIG. 8 is a view showing an example of document data after page layout;

FIG. 9 is a flow chart showing the print control sequence in an embodiment of the present invention;

FIG. 10 is a flow chart showing the sequence of a drawing process shown in FIG. 9;

FIG. 11 is a flow chart showing the sequence of a document acquiring process shown in FIG. 9;

FIGS. 12 and 13 are flow charts showing the web server control sequence in an embodiment of the present invention;

FIG. 14 is a view showing an example of the document data described with HTML;

FIG. 15 is a flow chart showing the web server control sequence in an embodiment of the present invention;

FIG. 16 is a view showing an example of display of document data described with a structured description language lacking the concept of page; and

FIG. 17 is a view showing an example of display of document data described with a structured description language after page layout.

### DETAILED DESCRIPTION OF THE PREFERRED EMBODIMENTS

First Embodiment

Now the present invention will be clarified in detail by preferred embodiments thereof with reference to the accompanying drawings.

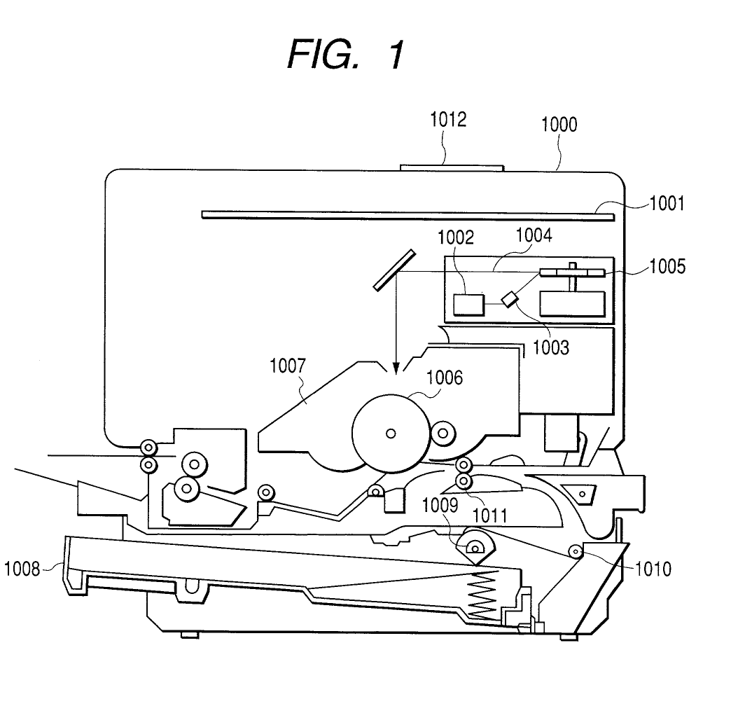

FIG. 1 is a cross-sectional view showing the internal configuration of a laser beam printer (LBP) suitable for the application of the present invention. The present embodiment is applicable not only to an LBP but naturally also to the printers of other types.

In the LBP shown in FIG. 1, there can be registered a character pattern or a fixed document format (form data) from an unrepresented data source. Referring to FIG. 1, a main body 1000 of the LBP can receive and store character information (character code), form information, macro instruction etc. supplied from an externally connected host computer, also prepares a character pattern or a form pattern corresponding to such information and forms an image on a recording sheet constituting a recording medium.

An operation panel 1012 is provided with operation switches, an LED display unit etc. A printer control unit 1001 controls the entire LBP 1000 and analyzes the character information supplied from the host computer. The control unit 1001 principally converts the character information into a video signal of corresponding character patterns for supply to a laser driver 1002.

A laser driver 1002, for driving a semiconductor laser 1003, executes on-off switching of a laser light 1004 emitted from the semiconductor laser 1003 according to the entered video signal.

The laser light 1004 is deflected in the lateral direction by a rotary polygon mirror 1005 thereby scanning an electrostatic drum 1006, thereby forming an electrostatic latent image of the character pattern thereon. The latent image is developed by a developing unit 1007 positioned around the electrostatic drum 1006 and is then transferred onto the recording paper. The recording paper is composed of a cut sheet, which is contained in a sheet cassette 1008 mounted on the LBP 1000, fed into the apparatus by a feed roller 1009 and conveying rollers 1010, 1011 and conveyed to the electrostatic drum 1006.

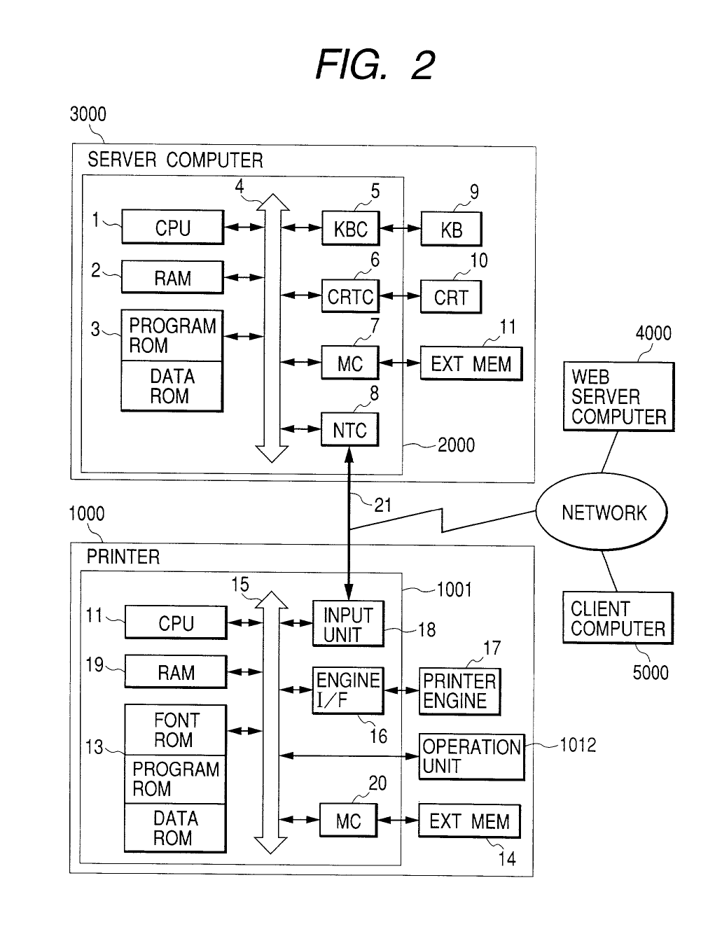

FIG. 2 is a block diagram showing the configuration of a printer control system embodying the present invention. In the following, this system will be explained by the laser beam printer shown in FIG. 1 as an example, but the present invention is naturally applicable to a single equipment, a system consisting of plural equipment or a system in which the processing is executed through a network such as a LAN, as long as the functions of the present invention can be exhibited.

Referring to FIG. 2, a host computer (server computer) 3000 is provided with a CPU 1 for executing fetching of the document data, conversion of data etc. based on a document processing program stored in a program ROM of a ROM 3, and such CPU 1 collectively controls the devices connected to a system device 4.

In the ROM 3, a program ROM stores the control program etc. for the CPU 1, a font ROM stores the font data to be used in the aforementioned data conversion, and a data ROM stores various data to be used in the aforementioned data conversion.

A RAM 2 serves as a main memory, a work area etc. of the CPU 1. A keyboard controller (KBC) 5 controls key input from a keyboard 9 and an unrepresented pointing device. A CRT controller (CRTC) 6 controls the display on a CRT display (CRT) 10. In the present embodiment, the keyboard 9 and the CRT display 10 are not essential, but are usually provided for the maintenance of the server computer and for confirming the operation status thereof.

A memory controller (MC) 7 controls the access to an external memory 11 such as a hard disk (HD) or a floppy disk (FD) storing a boot program, various applications, font data, user files, editing files etc. A network controller (NTC) 8 is connected with the printer 1000 through a predetermined bidirectional interface (interface) 21 and executes communication control with the printer 1000.

The CPU 1 can fetch the document data stored in the external memory 11 by controlling the memory controller 7 and can transfer the document data to the exterior by controlling the network controller 8.

In the printer 1000, a printer CPU 12 collectively controls the access to various devices connected to a system bus 15 based on a control program stored in the program ROM of the ROM 13 or in the external memory 14, and outputs an image signal as the output information to a printer engine 17 connected through an engine interface 16.

The program ROM of the ROM 13 may also store a control program of the CPU 12, including the process sequence of the flow chart of the present embodiment. The font ROM of the ROM 13 stores font data to be used in generating the aforementioned output information, and the data ROM of the ROM 13 stores information to be used on the host computer in case of a printer lacking the external memory 14 such as the hard disk. The CPU 12 is capable of communication with an external apparatus through an input unit 18, thereby transmitting the information in the printer to the external apparatus. A RAM 19 serves as a main memory, a work area etc. of the CPU 12 and the memory capacity thereof can be expanded by an optional RAM to be connected to an unrepresented expansion port.

The RAM 19 is used for example as an output information developing area, an environment data storing area, an NVRAM etc.

The aforementioned external memory 14 such as a hard disk or an IC card is access controlled by a memory controller (MC) 20. The external memory 14 is connected as an option, and stores document data, font data, form data etc. An input unit 18 constitutes the aforementioned operation panel and is provided with operation switches, an LED display etc.

The aforementioned external memory 14 is not limited to a single unit but may be provided in two or more units such as an optional font card in addition to the incorporated fonts and an external memory storing a program for interpreting a printer control language of different language system. Furthermore, there may be provided an unrepresented NVRAM for storing printer setting information from the operation panel 12.

The bi-directional interface 21 may be connected to the network as shown in FIG. 2. On the network, there are connected a web server computer 4000, a client computer 5000 etc. The web server computer 4000 stores the document data and transmits the document data to a requesting terminal in response to a request therefrom. The client computer 5000 receives the document data from the web server computer 4000 and displays an image based on the document data, on the browser. It also transmits a reference print instruction for the document data to the printer 1000.

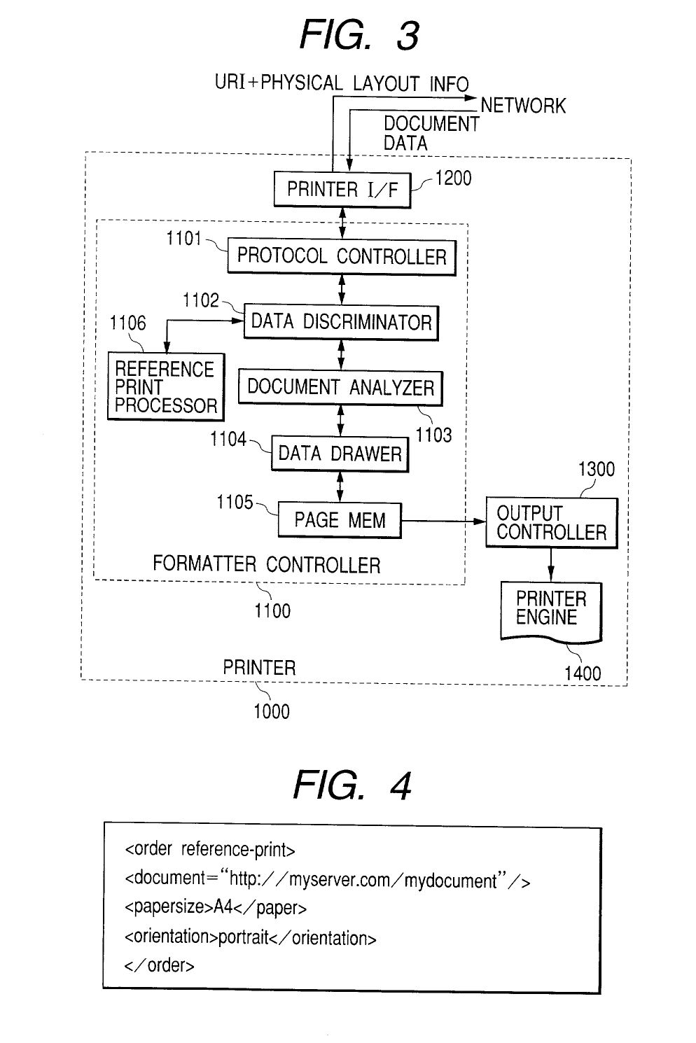

FIG. 3 is a functional block diagram showing the configuration of the printer 1000 of the present embodiment.

Referring to FIG. 3, the printer 1000 is principally composed of a formatter controller 1100, a printer interface 1200, an output controller 1300, and a printer engine 1400. The formatter controller 1100 is composed of a protocol controller 1101, a data discriminator 1102, a document data analyzer 1103, a data drawer 104, a page memory 1105 and a reference print instruction processor 1106.

The printer interface 1200 executes input/output operation with the exterior. The protocol controller 1101 executes communication with the exterior by analyzing and transmitting network protocol, and, for example if the HTTP (hyper text transfer protocol) is used as the protocol, executes acquisition of a document instructed by the URI (uniform resource identifier) and information transmission to the web server.

The data discriminator 1102 discriminates whether the received data are a reference print instruction or document data. If the received data are a reference print instruction, the data are transferred to the reference print instruction processor 1106, but if the data are document data, they are transferred to the document data analyzer 1103.

The reference print instruction processor 1106 extracts various information from the reference print instruction and transmits the necessary information to the exterior through the protocol controller 1101. Specific examples of the reference print instruction will be explained later, but it is possible to acquire the document data for example by transmitting the URI and the physical layout information of the document data.

The document data analyzer 1103 analyzes the document data described with the structured description language and executes conversion into intermediate codes of a more easily processable format. The intermediate codes generated in the document data analyzer 1103 are transferred to the data drawer 1104 and processed therein. The data drawer 1104 develops the above-mentioned intermediate codes into bit map data, which are drawn in succession in the page memory 1105.

In general, the formatter controller 1100 is not constituted by an actual hardware but by a computer system including a CPU, a ROM, and a RAM etc.

The output controller 1300 converts the content of the page memory 1105 into a video signal and transfers it to the printer engine 1400, which functions as a printing mechanism for forming a permanent visible image on the recording sheet according to the received video signal.

In the following there will be given a more detailed explanation on the reference print instruction, taking an example of the print instruction data indicating a reference print instruction. The print instruction data are described by the structured description language.

In the print instruction data shown in FIG. 4, the first line indicates that the data are not document data but are a reference print instruction. The document data to be actually printed are designated by the URI in the second line. The URI is the most common method for designating a document on the internet and will not therefore be explained in detail. The second line in FIG. 4 indicates requesting, by the HTTP protocol, a document entitled “mydocument” stored in a web server of a name “myserver.com”. The third line indicates the output sheet size and designates, in this case, an A4-sized sheet. The fourth line indicates the layout direction and designates, in this case, the portrait.

In this manner, by sending simple print instruction data to the printer 1000, the document “mydocument” can be printed in the A4 size and in the portrait layout, even if the document data are not directly transferred to the printer 1000.

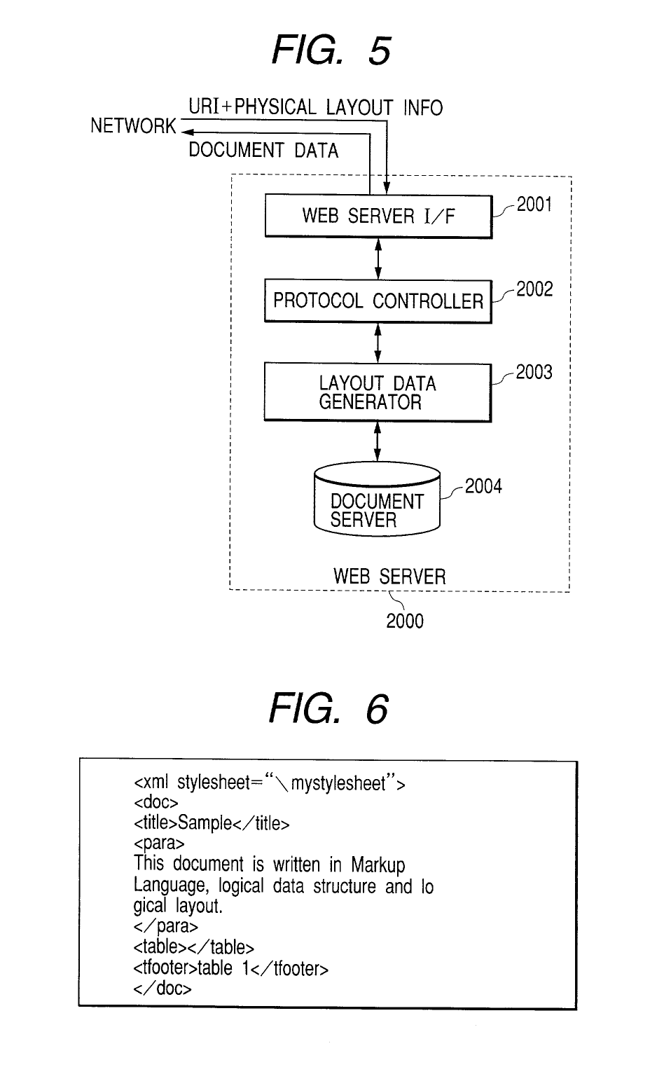

FIG. 5 is a block diagram showing the configuration of a web server 2000 in the server computer 3000 of the present embodiment, wherein the web server 2000 is principally composed of a server interface 2001, a protocol controller 2002, a layout data generator 2003 and a document server 2004.

In the present example, it is assumed that the server computer 3000 is provided with the web server function and with the document server 2004 storing the document data. It is also possible, however, that the server computer 3000 is not provided with the document server 2004 and acquires the necessary document data from the web server computer 4000 for the layout process to be explained in the following.

The web server interface 2001 executes input/output with the exterior. The protocol controller 2002 executes communication with the exterior by analyzing and transmitting network protocol, and, for example if the HTTP is used as the protocol, executes reception of information and transmission of the document data instructed by the URI. It also executes reception of the document data received by the URI.

The layout data generator 2003 executes page layout of the document data stored in the document server 2004 or the document data stored in an external web server computer. The document server 2004 stores the document file described with the structured description language.

Upon receiving the URI and the physical layout information from the printer 1000, the web server 2000 obtains the designated document data from the document server 2004, then causes the data generator 2003 to execute page layout of the document data based on the designated physical layout information, and transfers the generated document data to the printer 1000, thus functioning as a document providing apparatus. The external printing apparatus and the web server 2000 are connected through a network such as internet.

Also the web server 2000 may be so constructed, upon receiving the URI and the physical layout information from the printer 1000, to obtain the designated document data from the external web server computer by requesting thereto, then to cause the data generator 2003 to execute page layout of the document data based on the designated physical layout information, and to transfer the generated document data to the printer 1000, thus functioning as a document providing apparatus. The external printing apparatus and the web server 2000 are connected through a network such as internet.

In the following there will be explained, with reference to FIGS. 6, 7 and 8, a specific example of the document data stored in the document server 2004 and those generated by the layout data generator 2003.

FIG. 6 shows an example of the document described by XML. This document only indicates the meaning of the data by tagging to each data, and the information necessary for page layout is not embedded.

For example, in the third line, a tag <title> is attached character train data “Sample”. This tag means that the character train “Sample” is a “title”, but does not include the information indicating the size and the layout position of such character train. The manner of layout of the document is determined by a file generally called style sheet and describing the layout information. In the document shown in FIG. 6, the first line designates the style sheet to be applied.

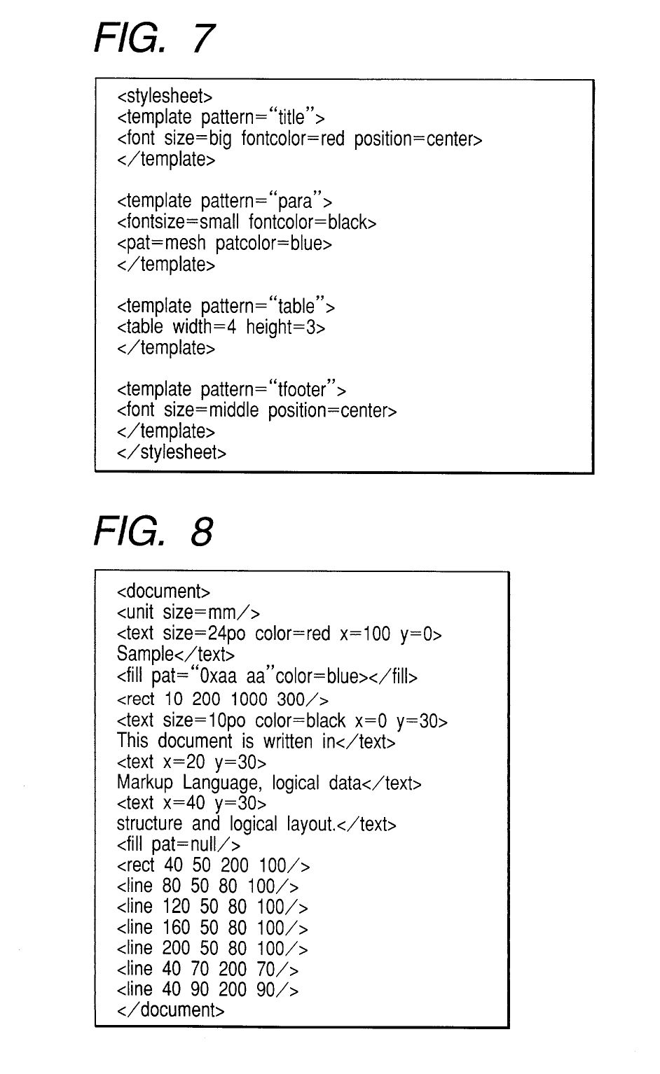

FIG. 7 shows a specific example of the style sheet. In FIG. 7, the second and third lines define the layout of “title”. More specifically, it is defined to be positioned at the center of a line with a large red font. The document server 2004 stores the document data as shown in FIG. 6 and the style sheet as shown in FIG. 7.

The document data shown in FIG. 6 are converted into the document data shown in FIG. 8, based on the style sheet shown in FIG. 7 and by the process of the layout data generator 2003.

FIG. 8 shows an example of the document data after layout to the physical page. The document data shown in FIG. 8 also describe the character size and the drawing position. For example the portion “title” shown in FIGS. 6 and 7 is laid out with a size of 24 points at a position (x, y)=(100, 0) mm.

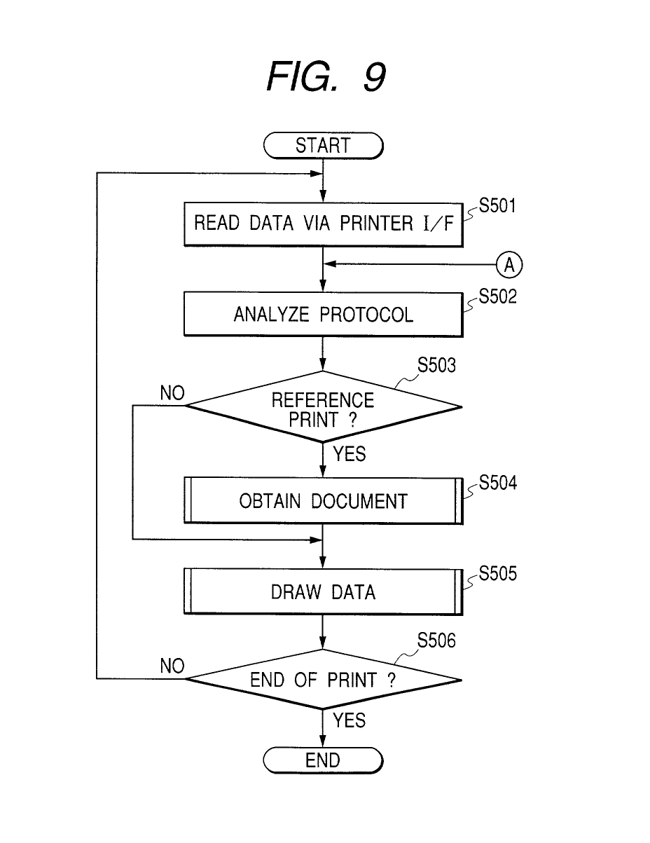

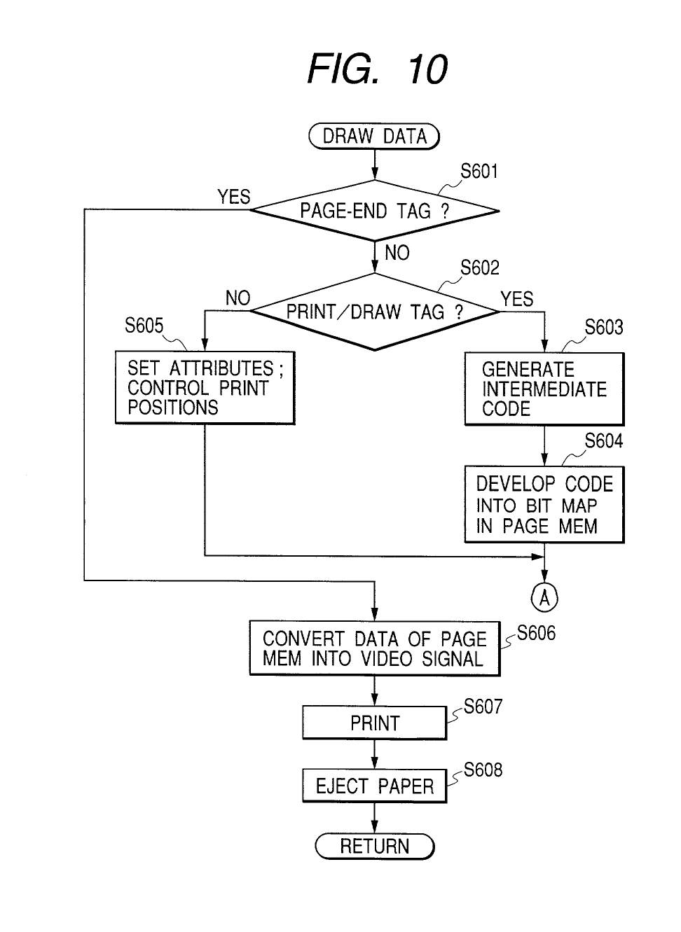

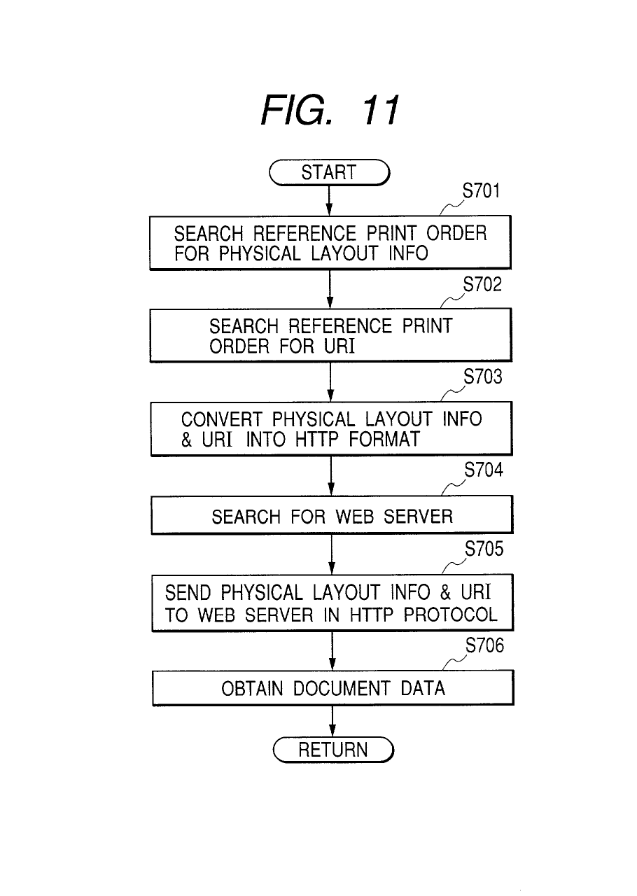

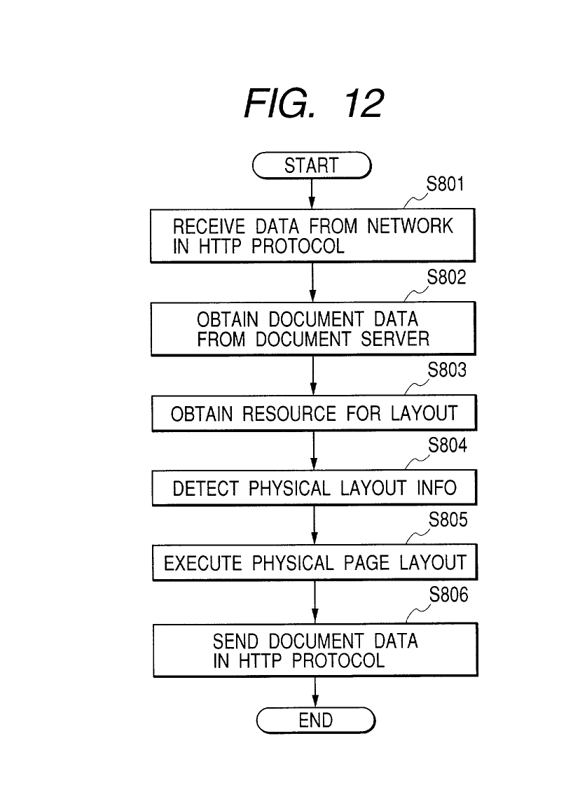

In the following there will be explained, with reference to flow charts in FIGS. 9, 10, 11 and 12, the entire print control sequence in the print system constructed as explained in the foregoing. S501 to S506 in FIG. 9, S601 to S608 in FIG. 10, S701 to S706 in FIG. 11 and S801 to S806 in FIG. 12 indicate process steps.

FIG. 9 is a flow chart of a main process from the start to the end of the operation of the printer 1000. A step S501 executes data reception from the network through the printer interface, and a step S502 analyzes the protocol.

A step S503 discriminates whether the received data are instruction data indicating a reference print instruction. If not, the sequence proceeds to a step S505 for executing a drawing process on the received data. If affirmative, a step S504 executes a drawing process after a document acquiring process.

Then a step S506 discriminates whether the document data have ended, and, if ended, the printing operation is terminated, but, if not ended, the process from the step S501 is repeated.

FIG. 10 is a flow chart showing the sequence of the drawing process in the step S505 in FIG. 9. This process actually executes the print process. A step S601 causes the document data analyzer 1103 to check a page end tag by analyzing the document data, and, in the presence of the page end tag, the sequence proceeds to a step S606.

On the other hand, if the step S601 identifies the absence of the page end tag, a step S602 discriminates whether the analyzed tag is a tag requiring a development into the page memory such as character printing or pattern drawing. If the tag does not require development process, the sequence proceeds to a step S605 for executing a process according to the tag such as attribute setting or print position control.

On the other hand, in case the sequence proceeds from the step S602 to S603, there are generated, according to the tag, intermediate codes of a form allowing easy development into the bit map. Receiving such intermediate codes, the data drawer 1104 executes development into the page memory 1105 (step S604). After the development process, the sequence returns to the step S502 in FIG. 9 to repeat the analyzing process for the document data.

Also in case the step S601 identifies the page end tag, the output controller 1300 converts the content of the page memory 1105 into a video signal for output to the printer engine 1400 (step S606).

The printer engine 1400 executes printing by forming a permanent visible image of the received video signal on the recording sheet (step S607). Then a step S608 discharges the print result, whereupon the print control process for a page is terminated.

FIG. 11 is a flow chart showing the document acquisition process in the step S504 in FIG. 9, for acquiring the document data to be printed.

At first a step S701 searches and recognizes the physical layout information described in the reference print instruction. In the example shown in FIG. 4, the sheet size “A4” and the layout direction “portrait” correspond to the physical layout information. The physical layout information is required for assigning the document data to the physical page, in order to print the document data matching the actual sheet.

Then a step S702 searches and recognizes the URI described in the reference print instruction. In the example shown in FIG. 4, ‘http://myserver.com/mydocument’ corresponds to such URI. Then a step S703 converts the recognized URI and the physical layout information into the HTTP format whereby the information transmission becomes ready for transmission.

The foregoing process is executed in the reference print instruction processor 1106, and the following process is to be executed in the protocol controller 1101. A step S704 searches the web server designated by the URI, and a step S705 transmits the URI and the physical layout information to the web server by the HTTP protocol. Then a step S706 receives the document data transferred from the web server, whereupon the process is terminated.

In the foregoing configuration, the printer 1000 searches the web server and the URI and the physical layout information are transmitted to thus found web server. However, instead of the search for the web server by the printer 1000, it is also possible that the server computer 3000 searches the web server and acquires the document data. In such case, the printer 1000 transmits the URI and the physical layout information without change to the server computer 3000.

Also the printer 1000 may change, if necessary, the physical layout information contained in the instruction data of the reference print instruction and transmit such changed physical layout information. For example, in case the reference print instruction designates “A3” sheet size but the printer 1000 supports the “A4” size only or the A3-sized sheet is currently absent in the feeding slot, there is transmitted the physical layout information designating the “A4” sheet size.

In this manner the printer 1000 may change and transmit the physical layout information in the instruction data to the server according to the function or status of the printer 1000, whereby appropriate printing can be executed without particular confirmation of the function or status of the printer 1000 by the user.

Also, if the instruction data do not contain the necessary physical layout information, the printer 1000 may determine the physical layout information by itself and transmit thus determined physical layout information. For example, if the instruction data do not designate the sheet size, the printer 1000 transmits the physical layout information designating a default sheet size or the sheet size of the sheet currently available at the feeding slot.

In this manner the printer 1000 may determine the physical layout information by itself according to the function or status of the printer 1000 and transmits such physical layout information to the server, whereby appropriate printing can be executed even in case the user cannot designate or forgets to designate the physical layout information.

FIG. 12 is a flow chart showing a main process from the start to the end of the function of the web server 2000.

At first a step S801 executes reception of the data from the network by the HTTP protocol, and such process is executed in the web server interface 2001.

Then a step S802 obtains the document data designated by the URI from the document server 2004. If the URI indicates document data stored in another web server, the designated document data are obtained by sending a request to such web server.

Then a step S803 acquires the resources necessary for layout. For example the style sheet shown in FIG. 7 corresponds to such necessary resources.

Then a step S804 detects the physical layout information informed by the HTTP protocol, and then a step S805 executes the physical page layout process.

More specifically, there is executed a formatting process based on the style sheet obtained in the step S803 and the physical layout information detected in the step S804. For example in case the physical layout information designates a sheet size “A4”, the acquired document data are converted into document data described in the structured description language enabling page layout, in such a manner that the document based on the document data can be appropriately accommodated in the A4 sheet size.

When a step S805 detects the end of the process, the sequence proceeds to a step S806 for transmitting the document data after physical page layout process, utilizing the HTTP protocol, whereby all the process is terminated.

Second Embodiment

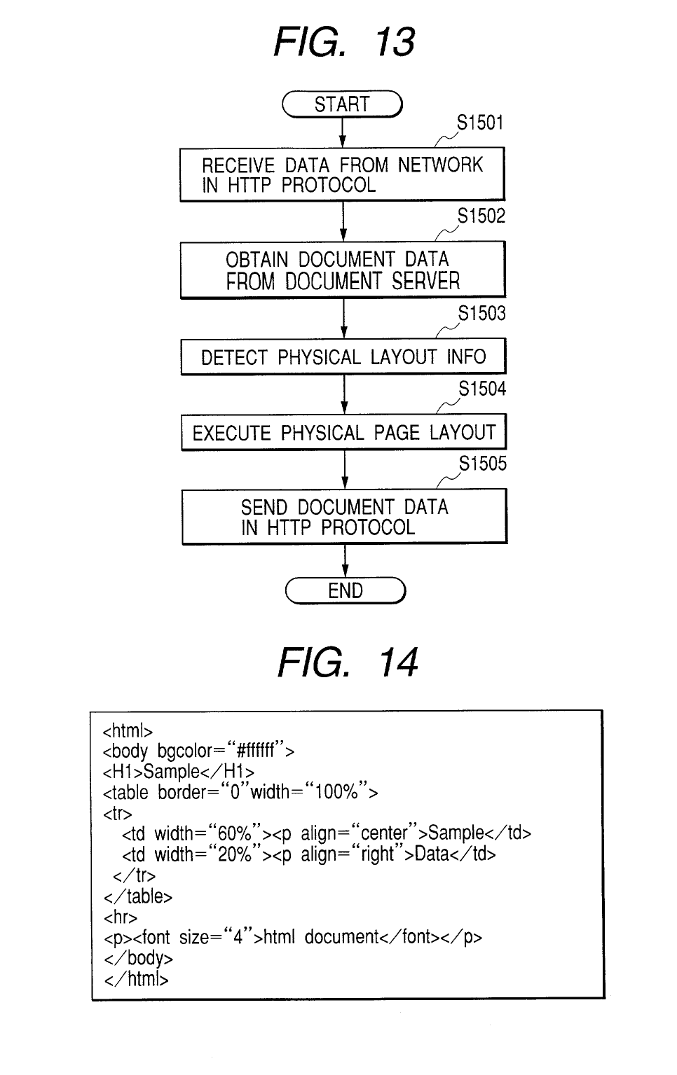

The foregoing embodiment has explained a case where the XML is used as the description language of the document stored in the document server 2004, but the present embodiment shows a case of utilizing the HTML with reference to FIGS. 13 and 14. In FIG. 13, S1501 to S1505 show process steps.

FIG. 13 is a flow chart showing a main process from the start to the end of the operation of the web server 2000.

At first a step S1501 executes data reception from the network by the HTTP protocol. This process is executed in the web server interface 2001. Then a step S1502 obtains the document data designated by the URI from the document server 2004. In case the URI indicates document data stored in another web server, the designated document data are obtained by sending a request to such web server.

In the foregoing embodiment, the acquisition of the resources necessary for layout is executed at this point, but such process is unnecessary because the HTML contains the layout information.

Then a step S1503 detects the physical layout information informed by the HTTP protocol and then a step S1504 executes the physical page layout process. Thus the formatting process is executed only based on the information obtained in the steps S1502 and S1503. After the process of the step S1504, a step S1505 transmits, by the HTTP protocol, the document data after physical page layout whereby all the process is terminated.

FIG. 14 shows a specific example of the document data described with HTML to be employed in the present embodiment, wherein an <HT> tag in the third line indicates the display with the largest font. Since the HTML description language itself contains the layout information, the process sequence can be simplified in comparison with that in the foregoing embodiment.

Third Embodiment

In the present embodiment there will be explained an example of printing only a page designated by the reference print instruction, by designating the page to be printed as one of the physical page layout information.

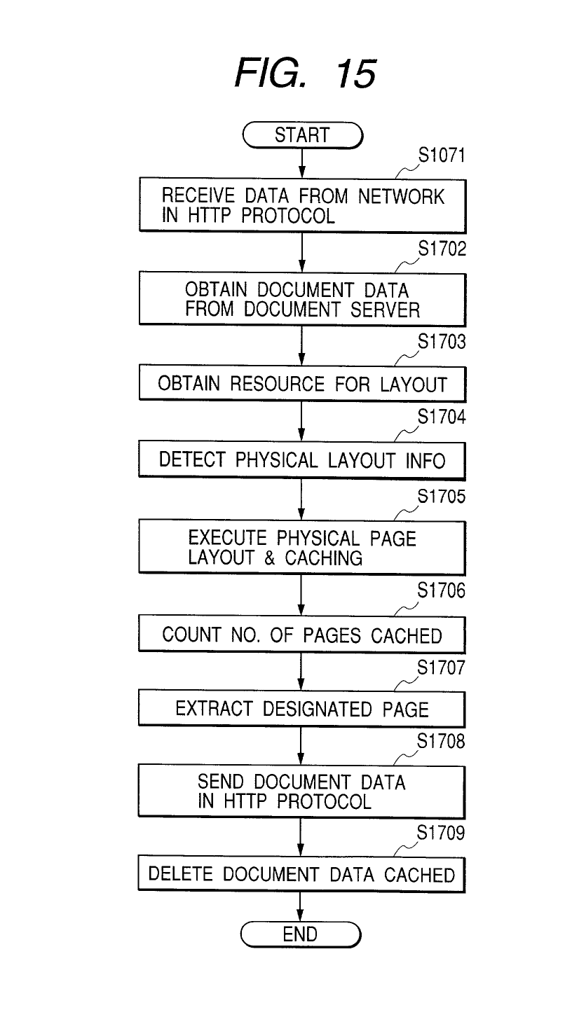

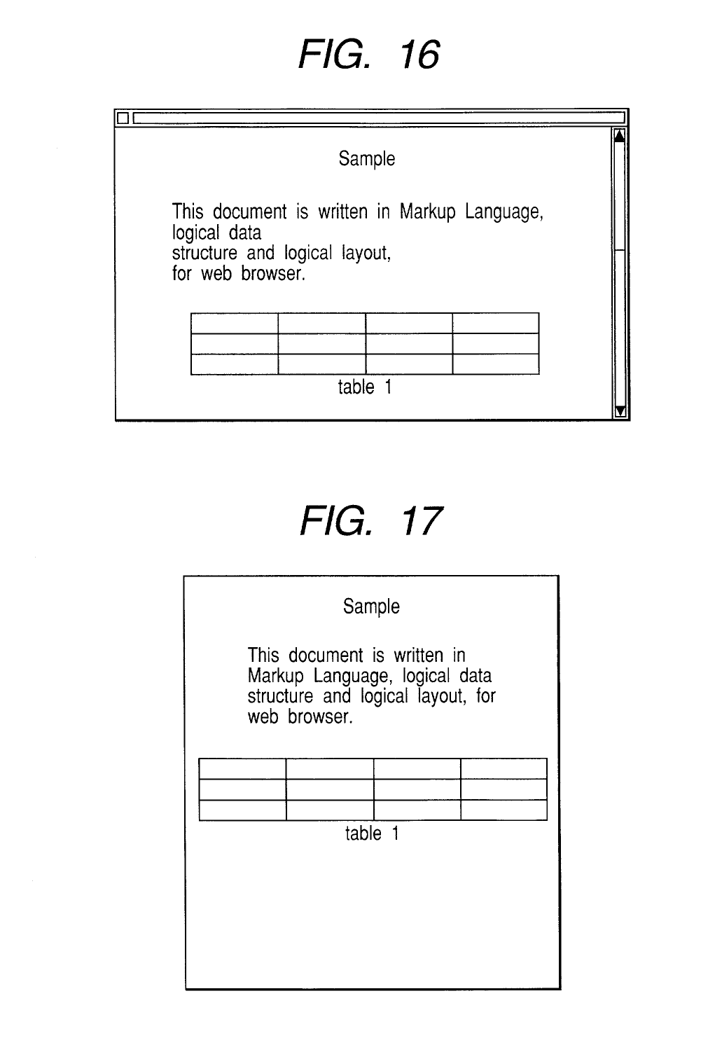

FIG. 15 is a flow chart showing a main process from the start to the end of the operation of the web server 2000, wherein S1701 to S1705 indicate process steps. At first a step S1701 executes data reception from the network by the HTTP protocol. This process is executed in the web server interface 2001.

Then a step S1702 obtains the document designated by the URI from the document server 2004, and a step S1703 acquires the resources necessary for layout. The process up to this point is same as that in the foregoing first embodiment and will not, therefore, be explained further.

Then a step S1704 detects the physical layout information informed by the HTTP protocol. In the present embodiment, the page number to be outputted is designated in the reference print instruction, and such page number in addition to the sheet size and the layout direction are informed as the physical layout information. Thereafter a step S1705, while executing the physical page layout process, temporarily stores (caching) the document data after the physical page layout process in the memory, which can be composed of a memory or a hard disk.

Then a step S1706 counts the pages of the temporarily stored document data, and then a step S1707 extracts the document data of the designated page from the memory.

After the process up to the step S1707, a step S1708 transmits the extracted document data by the HTTP protocol. Finally a step S1709 deletes the document data temporarily stored in the memory, whereby all the process is terminated.

Thus, by informing the page number as the physical layout information, the necessary pages only can be efficiently printed even in the document described in the structured description language.

Other Embodiments

In the foregoing embodiment there has been explained an example in which the instruction data indicating the reference print instruction are described with the structured description language, but such instruction data need not necessarily described in the structured description language as long as such data instruct the output of the document data in the structured description language. For example, instruction is also possible with the HTTP protocol only.

Also in the foregoing embodiments there has been explained an example in which the document server is a constituent of the web server, but the document server may be provided externally. For example, it can be the hard disk of another personal computer.

Also in the foregoing embodiments, there has been explained an example of informing the sheet size and the layout direction as the layout information to the physical page, but such example is not restrictive and there may be utilized any information to be referred to at the layout operation. For example, by informing the instruction for the page enlargement/reduction and the plural page printing, the server can execute the formatting process in consideration of such information.

Also in the foregoing embodiments there is informed the information relating to the physical page layout among the information instructed in the reference print instruction, but it is also possible to inform information not instructed in the reference print instruction if such information is to be referred to at the layout operation. For example the resolution specific to the printing apparatus may be informed to execute more rigorous physical page layout.

Furthermore, in the foregoing embodiments, all the document data temporarily stored in the memory are deleted once the document data are transmitted, but such document data may be left, instead of deletion, if the temporary memory has a spare capacity. Such process allows to expedite the process of the next time in case the same document is to be printed again.

Also the printer 1000 and the server computer 3000 need not be directly connected, the data transmitted from the printer 1000 may be transferred to the server computer 3000 through various devices such as a gateway or a router. Similarly the data transmitted from the server computer 3000 may be transferred to the printer 1000 through various devices such as a gateway or a router.

The present invention can naturally be attained also in a case where a memory medium storing program codes of a software realizing the functions of the aforementioned embodiments is supplied to a system or an apparatus and the computer (or CPU or MPU) of such system or apparatus reads and executes the program codes stored in the memory medium.

In such case, the program codes themselves read from the memory medium realize the novel functions of the present invention, and the memory medium storing such program codes constitutes the present invention.

The memory medium supplying the program codes can be, for example, a floppy disk, a hard disk, a magneto optical disk, an optical disk, a CD-ROM, a CD-R, a magnetic tape, a non-volatile memory card or a ROM.

Also the functions of the aforementioned embodiments can be realized not only in a case where the computer executes the read program codes but also in case where an operating system or the like functioning on the computer executes all the actual processes or a part thereof according to the instruction of the program codes.

Furthermore, the functions of the aforementioned embodiments can also be realized in a case where the program codes read from the memory medium are once stored in a function expansion board inserted into the computer or a function expansion unit connected to the computer and a CPU or the like provided in the function expansion board or the function expansion unit executes all the processes or a part thereof according to the instruction of such program codes.

The present invention is further applicable to a case where a program is delivered to a requesting person through a communication line such as personal computer communication from a memory medium storing the program codes of a software realizing the functions of the aforementioned embodiments.

As explained in the foregoing, the present invention allows printing the document data in the actual output sheet size with satisfactory layout, even in case of printing by the reference print instruction.

Also, since the information for acquiring the document data includes position information (for example URI) indicating the storage position of the document data, the server, upon receiving the position information from the printing apparatus, can execute the layout process by obtaining the designated document internally or externally.

Also the printing apparatus can acquire the document data by transmitting the URI and the physical layout information, received from the external apparatus, to the server.

Also since the physical layout information includes the information on the sheet size and the layout direction, the document data can be printed in the desired sheet size and layout direction by transmitting a simple instruction to the printing apparatus from the external apparatus, without transferring the document data directly to the printing apparatus.

Also since the physical layout information includes the information on the page number, the necessary page only can be efficiently printed even in the document data described in the structured description language, by informing the page number to be printed.

Also in case the structured description language is XML, the layout of the document data can be determined by applying a file describing the layout information, called style sheet.

Also in case the structured description language is HTML, the process sequence can be simplified since the structured description language itself includes the layout information.

Furthermore, by providing a server for converting the document data into document data described in the structured description language capable of layout into the physical page, the server, upon receiving the URI and the physical layout information from the printing apparatus, can acquire the designated document, execute the formatting process based on the physical layout information and providing the printing apparatus with the generated document data, whereby a high-quality efficient print system of load dispersion type can be realized. Therefore, the printing apparatus, even if lacking the highly advanced function such as formatting process, can print the document data described with the structured description language lacking the page concept.

Also the printing apparatus can change the physical layout information instructed from the user according to the function or status of the printing apparatus and transmits such information to the server, whereby the appropriate printing can be achieved without requiring the user to check the function or status of the printing apparatus.

Also the printing apparatus can determine the physical layout information according to the function or status of the printing apparatus and transmits such information to the server, whereby the appropriate printing can be achieved even in case the user cannot or forgets to designate the physical layout information.

What is claimed is:

1. An image forming apparatus capable of outputting an image on a recording medium based on data described with a structured description language, comprising:
informing means for informing, to an external apparatus, information for acquiring data and layout information necessary for assigning an image based on the data to the recording medium; and
acquisition means for acquiring data outputted from said external apparatus according to the information by said informing means.

2. An image forming apparatus according to claim 1, wherein the information for acquiring the data is information for identifying the data.

3. An image forming apparatus according to claim 2, wherein the information for identifying the data is represented by URI.

4. An image forming apparatus according to claim 1, further comprising:
reception means for receiving a print instruction including information indicating the position of storage of data and said layout information;
wherein said informing means informs information included in said print instruction.

5. An image forming apparatus according to claim 1, wherein said acquisition means acquires the data through a network.

6. An image forming apparatus according to claim 1, wherein said layout information includes information indicating the sheet size or the layout direction.

7. An image forming apparatus according to claim 1, wherein said layout information is information designating a page and said acquisition means acquires data corresponding to the designated page.

8. An image forming apparatus according to claim 1, wherein said structured description language is XML or HTML.

9. An image forming apparatus according to claim 1, wherein said apparatus is a printing apparatus.

10. An image forming system composed of an image forming apparatus capable of outputting an image on a recording medium based on data described in a structured description language and an external apparatus for executing a conversion process of the data described with said structured description language, the system comprising:
informing means for informing, to an external apparatus, information for acquiring data and layout information necessary for assigning an image based on the data to the recording medium;
acquisition means for acquiring data based on the information for acquiring data;
conversion means for converting the acquired data based on said layout information;
transfer means for transferring the converted data from said external apparatus to said image forming apparatus; and
output means for outputting an image by analyzing the transferred data.

11. An image forming apparatus capable of outputting an image on a recording medium based on data described with a structured description language, comprising:
reception means for receiving a print instruction including layout information required for assigning an image based on the data to the recording medium;
changing means for changing the layout information received by said reception means;
informing means for informing, to an external apparatus, layout information changed by said changing means; and
acquisition means for acquiring data outputted from said external apparatus in response to the information by said informing means.

12. An image forming apparatus according to claim 11, wherein said changing means changes said layout information according to the function or status of said image forming apparatus.

13. An image forming apparatus according to claim 11, wherein said layout information is information indicating the sheet size.

14. An image forming apparatus capable of outputting an image on a recording medium based on data described with a structured description language, comprising:
reception means for receiving a print instruction;
determination means for determining layout information required for assigning an image based on the data to the recording medium, in case the received print instruction does not include said layout information;
informing means for informing, to an external apparatus, layout information determined by said determination means; and
acquisition means for acquiring data outputted from said external apparatus in response to the information by said informing means.

15. An image forming apparatus according to claim 14, wherein said determination means determines said layout information according to the function or status of said image forming apparatus.

16. An image forming apparatus according to claim 14, wherein said layout information is information indicating the sheet size.

17. An image forming method for outputting an image on a recording medium based on data described with a structured description language, comprising steps of:
informing, to an external apparatus, information for acquiring data and layout information necessary for assigning an image based on the data to the recording medium; and
acquiring data outputted from said external apparatus according to the information by said informing step.

18. An image forming method according to claim 17, wherein the information for acquiring the data is information for identifying the data.

19. An image forming method according to claim 18, wherein the information for identifying the data is represented by URI.

20. An image forming method according to claim 17, further comprising steps of:
receiving a print instruction including information indicating the position of storage of data and said layout information; and
informing information included in said print instruction.

21. An image forming method according to claim 17, wherein the data are acquired through a network.

22. An image forming method according to claim 17, wherein said layout information includes information indicating the sheet size or the layout direction.

23. An image forming method according to claim 17, wherein said layout information is information designating a page and there are acquired data corresponding to the designated page.

24. An image forming method according to claim 17, wherein said structured description language is XML or HTML.

25. An image forming method according to claim 17, wherein said method is realized in a printing apparatus.

26. An image forming method for outputting an image on a recording medium based on data described with a structured description language, comprising steps of:
receiving a print instruction including layout information required for assigning an image based on the data to the recording medium;
changing the received layout information;
informing, to an external apparatus, the changed layout information; and
acquiring data outputted from said external apparatus in response to the information by said informing step.

27. An image forming method according to claim 26, wherein said layout information is changed according to the function or status of said image forming apparatus.

28. An image forming method according to claim 26, wherein said layout information is information indicating the sheet size.

29. An image forming method for outputting an image on a recording medium based on data described with a structured description language, comprising steps of:
receiving a print instruction;
determining layout information required for assigning an image based on the data to the recording medium, in case the received print instruction does not include said layout information;
informing, to an external apparatus, the determined layout information; and
acquiring data outputted from said external apparatus in response to the information by said informing step.

30. An image forming method according to claim 29, wherein said layout information is determined according to the function or status of said image forming apparatus.

31. An image forming method according to claim 29, wherein said layout information is information indicating the sheet size.

32. A memory medium storing a program to be executed by an image forming apparatus capable of outputting an image on a recording medium based on data described with a structured description language, the program causes a computer to execute:
an informing step of informing, to an external apparatus, information for acquiring data and layout information necessary for assigning an image based on the data to the recording medium; and
an acquisition step of acquiring data outputted from said external apparatus according to the information by said informing step.

33. A memory medium storing a program to be executed by an image forming apparatus capable of outputting an image on a recording medium based on data described with a structured description language, the program causes a computer to execute:
a reception step of receiving a print instruction including layout information required for assigning an image based on the data to the recording medium;
a changing step of changing the layout information received by said reception step;
an informing step of informing, to an external apparatus, the layout information changed by said changing step; and
an acquisition step of acquiring data outputted from said external apparatus in response to the information by said informing step.

34. A memory medium storing a program to be executed by an image forming apparatus capable of outputting an image on a recording medium based on data described with a structured description language, the program causes a computer to execute:
a reception step of receiving a print instruction;
a determination step of determining layout information required for assigning an image based on the data to the recording medium, in case the received print instruction does not include said layout information;
an informing step of informing, to an external apparatus, the layout information determined by said determination step; and
an acquisition step of acquiring data outputted from said external apparatus in response to the information by said informing step.

35. A program to be executed by an image forming apparatus capable of outputting an image on a recording medium based on data described with a structured description language, the program comprising:
an informing step of informing, to an external apparatus, information for acquiring data and layout information necessary for assigning an image based on the data to the recording medium; and
an acquisition step of acquiring data outputted from said external apparatus according to the information by said informing step.

36. A program to be executed by an image forming apparatus capable of outputting an image on a recording medium based on data described with a structured description language, the program comprising:
a reception step of receiving a print instruction including layout information required for assigning an image based on the data to the recording medium;
a changing step of changing the layout information received by said reception step;
an informing step of informing, to an external apparatus, the layout information changed by said changing step; and
an acquisition step of acquiring data outputted from said external apparatus in response to the information by said informing step.

37. A program to be executed by an image forming apparatus capable of outputting an image on a recording medium based on data described with a structured description language, the program comprising:
a reception step of receiving a print instruction;
a determination step of determining layout information required for assigning an image based on the data to the recording medium, in case the received print instruction does not include said layout information;
an informing step of informing, to an external apparatus, the layout information determined by said determination step; and
an acquisition step of acquiring data outputted from said external apparatus in response to the information by said informing step.
